(19) United States
(12) Patent Application Publication
(10) Pub. No.: US 2015/0232333 A1
(43) Pub. Date: Aug. 20, 2015

(54) Method and Apparatus for a Directly Electrically Heated Flow-Through Chemical Reactor

(71) Applicant: MKS Instruments, Inc., Andover, MA (US)

(72) Inventors: Johannes Seiwert, Berlin (DE); Christiane Gottschalk, Berlin (DE); Joachim Lohr, Berlin (DE); Martin Blacha, Berlin (DE)

(73) Assignee: MKS Instruments, Inc., Andover, MA (US)

(21) Appl. No.: 14/189,649

(22) Filed: Feb. 25, 2014

Related U.S. Application Data
(60) Provisional application No. 61/956,189, filed on Feb. 14, 2014.

(51) Int. Cl. C01B 13/02; B01J 19/00

(52) U.S. Cl. CPC C01B 13/0203; B01J 19/0053

(57) ABSTRACT

A system and method for facilitating a chemical reaction is provided. The system can have an electrically conductive member. The electrically conductive member is capable of holding a chemical mixture. The electrically conductive member is directly coupled to a power source and is heated when the power source is on. When a chemical mixture is within the electrically conductive member and the power source is on, the chemical mixture is heated such that a chemical reaction can occur.

### CROSS REFERENCE TO RELATED APPLICATION

This application is a continuation-in-part of U.S. Ser. No. 14/181,182, filed on Feb. 14, 2014, which is owned by the assignee of the instant application and the disclosure of which is incorporated herein by reference it its entirety.

### FIELD OF THE INVENTION

This invention relates generally to devices, systems, and methods employed in chemical vapor deposition (CVD) and wet wafer processing applications. In particular, the invention relates to directly coupling a conductive member to an electrical power source to heat the conductive member in order to create a chemical reaction from one or more chemical substances disposed within the conductive member.

### BACKGROUND OF THE INVENTION

When manufacturing semiconductor devices, a variety of chemicals are used. Chemical substances can be used to etch wafers, clean chambers, and in countless other operations that occur during semiconductor device manufacturing.

Many of the chemical substances used during semiconductor device manufacturing processes need to be heated. One example is ozone excess gas. Ozone gas can be used to create ozonated deionized water that can be used for wafer surface cleaning, passivation, native oxide removal and/or removal of photoresist. It can be harmful to release ozone gas into the environment, making it desirable to destruct the ozone excess gas. The application of heat can cause the ozone gas to be destructed into oxygen. By exposing ozone to temperatures of over 250° C., the ozone gas can be destructed. By destructing the ozone gas, the release of harmful chemical substances into the environment can be avoided.

Other chemical substances that can require heating during the manufacture of semiconductor devices are fluorine compounds, such as CxFy, NF3, CHF3, and SF6. Other gases may also require heating.

Current methods and apparatus for heating chemical substances during semiconductor manufacturing include heating a chemical reactor using a heating element. For example, FIG. 1 is a schematic representation of an exemplary system 100 for destructing ozone according to the prior art. The system 100 includes an input 110, an output 115, a tube 120, a heating element 130, a cooling element 140, and a control unit 150. In operation, the control unit 150 heats the heating element 130 to a desired temperature. As such, a chemical substance (e.g. ozone) directed through the chemical input 110 into the tube 120 is heated by the element 130. Once heated, the chemical substance flows through the cooling element 140, which cools the chemical substance before it exits the system via output 115.

One problem with system 100 is that the tube 120 may need to be welded or otherwise manipulated (e.g., bent) causing the heat distribution to the chemical substance to be non-uniform. In addition, portions of the tube 120 can have unwanted condensation build-up and dead-ends, further contributing non-uniform heat distribution.

Current methods can also have a longer than desirable heat-up time due to, for example, additional heat resistance caused by the presence of a heating element. Current methods and apparatus' can be very expensive, large, and/or heavy due to, for example, size, cost and/or weight of a heating element

Another problem is that existing thermal reactors typically do not have good chemical resistance and/or cannot operate over a range of chemical substances, due to, for example, the inability of heating elements to withstand chemicals having a high corrosion. Poor chemical resistance can result in premature corrosion of a reactor.

Another problem with current methods is that for ozone destruction, the ozone conversion rate from ozone gas into oxygen can be less than 95%.

### SUMMARY OF THE INVENTION

The invention includes heating a chemical mixture disposed within a heated electrically conductive member (e.g., an electrically conductive chemical reactor). The chemical reactor is heated by directly electrically coupling the chemical reactor to a power source. When the power source is turned on, the chemical reactor functions as a heating element with respect to the chemical mixture disposed within the reactor.

One advantage of the invention is that heating, reacting and housing of chemical substances can all be achieved with the same structural component (e.g., the electrically conductive member). Heating the chemical mixture by heating the chemical reactor allows for elimination of a separate heating element. As such, another advantage of the invention is reduced size and/or cost.

Other advantages of the invention include a more uniform heat distribution and a shorter heating-up time. These advantages are achieved by eliminating the heating element that creates additional resistance in the system. Another advantage of the invention is that the system has improved chemical resistance and/or can operate over a range of chemical substances because the chemical reactor alone, and not a separate heating element, is subject to the chemical substance. Another advantage of the invention is that, for ozone destruct applications, the ozone conversion from ozone gas into oxygen can be greater than 95% because of more uniform heat distribution and quicker heat up time. Another advantage of the invention is the minimization of condensation build-up due to substantially complete uniform heated chemical reactor and the elimination of dead volumes by the one tube design of the reactor.

In one aspect, the invention involves a method of facilitating a chemical reaction. The method involves directly coupling an electrically conductive member and a source of electrical power, the electrically conductive member having an interior region configured to be substantially resistant to chemical corrosion and capable of retaining a chemical mixture therein. The method also involves providing the chemical mixture to the interior region of the electrically conductive member. The method also involves heating the electrically conductive member to a predetermined temperature by controlling the electrical power applied to the electrically conductive member to cause a chemical reaction within the chemical mixture.

In some embodiments, the chemical reaction is ozone destruction. In some embodiments, the method further involves heating the electrically conductive member to a predetermined temperature that is greater than 200 degrees Celsius. In some embodiments, selecting the predetermined temperature based on the chemical mixture, the type of electrically conductive member, or any combination thereof.

In some embodiments, the method involves cooling a section of the electrically conductive member to cool the chemical mixture upon exiting the electrically conductive member. In some embodiments, the electrically conductive member is a metallic tube. In some embodiments, the electrically conductive member is single structure that is electrically and thermally conductive.

In another aspect, the invention involves a system for facilitating a chemical reaction. The system includes a metallic tube that is substantially resistant to chemical corrosion and capable of retaining a chemical mixture therein, the metallic tube having a first section and a second section. The system also includes a power source directly electrically coupled to the metallic tube, the power source being configured to heat the first section of the metallic tube. The system also include a controller electrically coupled to the power source, the controller controls power to the metallic tube such that when the chemical mixture flows into the metallic tube the chemical mixture is heated to cause a chemical reaction within the chemical mixture.

In some embodiments, the power source and metallic tube are coupled by connecting one or more electrical wires to the metallic tube along the first section of the metallic tube. In some embodiments, the power source and the metallic tube are coupled by direct induction of electrical power into the metallic tube. In some embodiments, the metallic tube is configured to complete a secondary winding a transformer. In some embodiments, direct induction is performed by eddy currents.

In some embodiments, the system includes a cooling section connected to the metallic tube along a second section of the metallic tube.

In some embodiments, the second section of the metallic tube is positioned relative to a coil shaped metallic tube that has coolant flowing there through such that the second section of the metallic tube is cooled.

In some embodiments, the system includes a heated section of the first section of the metallic tube that is connected to the second section of the metallic tube is in fluid connection with an inlet of the first portion of the metallic tube such that heat from the heated section of the first section of the metallic tube heats the chemical mixture entering the first portion of the metallic tube.

In some embodiments, the metallic tube is up to 15 meters in length. In some embodiments, the first section of the metallic tube, the second section of the metallic tube or both have a coil shape. In some embodiments, the power source is a transformer. In some embodiments, the transformer has 10 loops on a secondary side of the transformer.

In some embodiments, the power source is a DC source. In some embodiments, the power source is a switching power supply. In some embodiments, the power source is a controlled source.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic representation of an exemplary system for destructing ozone, according to the prior art.

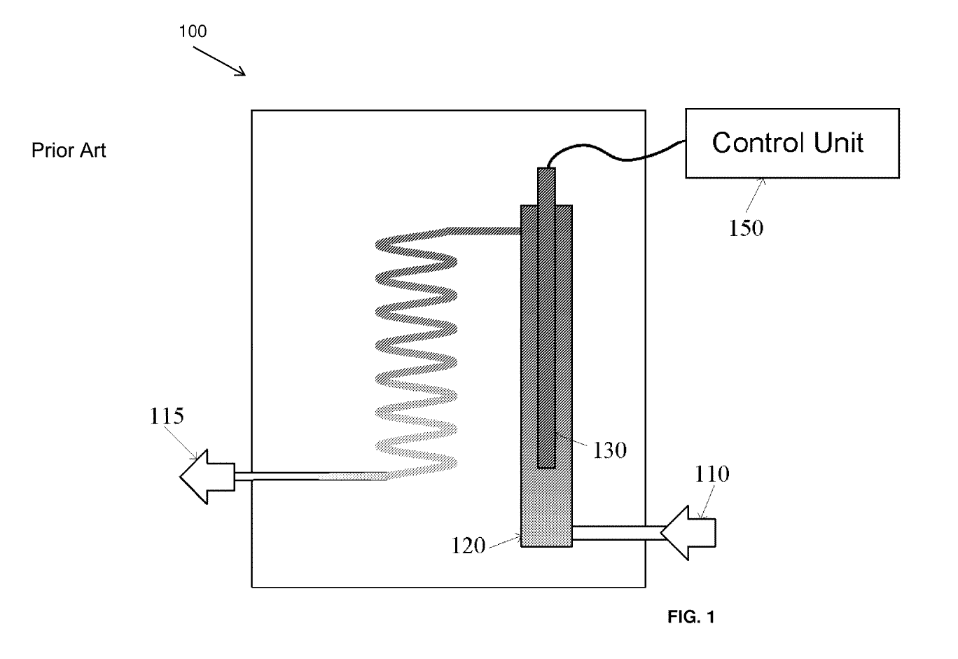

FIG. 2 is a schematic representation of a system for facilitating a chemical reaction, according to an illustrative embodiment of the invention.

FIG. 3 is schematic representation of a system for facilitating a chemical reaction, according to an illustrative embodiment of the invention.

FIG. 4 is a flow diagram for a method of facilitating a chemical reaction, according to an illustrative embodiment of the invention.

### DETAILED DESCRIPTION

Generally, the invention includes directly coupling an electrically conductive member (e.g., a metallic tube) and a power source. The electrically conductive member is capable of retaining a chemical mixture therein. The power source applies power to the electrically conductive member. The electrically conductive member heats up as a result of the applied power. The electrically conductive member has an interior region that allows for a chemical mixture to flow therethrough.

When a chemical mixture is disposed within the interior region of the electrically conductive member and power is applied, the heat generated in the electrically conductive member transfers to the chemical mixture causing the chemical mixture to be heated. A portion of the electrically conductive member can be cooled. The cooled portion of the electrically conductive member can cool the chemical mixture flowing through the electrically conductive member. The chemical mixture can be cooled, in one embodiment, after the chemical mixture has been heated.

The electrically conductive member can be a metallic tube. The metallic tube can be subdivided in first portion and a second portion. The first portion is directly coupled to a power source. When the power source is turned on, it directly heats the first portion of the metallic tube. The second portion of the metallic tube is cooled by a coolant. The metallic tube formed of a material that is substantially resistant to chemical corrosion (e.g., Alloy 625).

In some embodiments, a clamp is directly electrically connected to the metallic tube. A contact surface between the clamp and the metallic tube can be positioned and sized such that electrical transition resistance is minimized. The clamp can be cooled so that if the metallic tube is fully heated, the clamp can operate within its specified temperature range. In some embodiments, the clamp is cooled by liquid cooling (e.g., water, oil), air cooling (convection cooling) or any combination thereof.

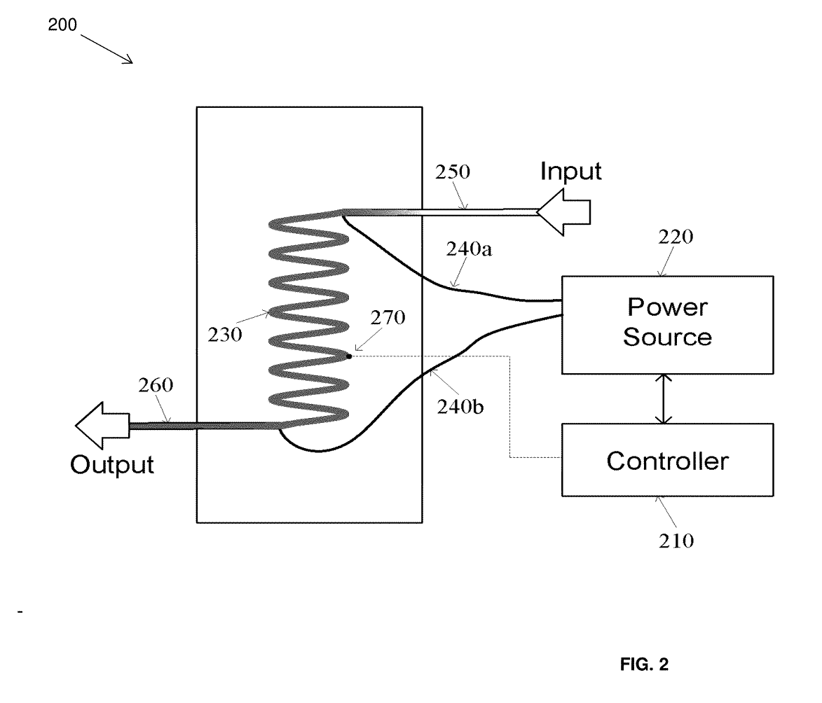

FIG. 2 is a schematic representation of a system 200 for facilitating a chemical reaction, according to an illustrative embodiment of the invention. The system 200 includes a controller 210, a power source 220, an electrically conductive member 230, one or more electrical connectors 240a, 240b, generally, 240, a temperature sensor 270, a fluidic input to the electrically conductive member 250 and a fluidic output to the electrically conductive member 260.

The controller 210 is in communication with the power source 220 and the temperature sensor 270. In some embodiments, the controller 210 is a thermostat. In some embodiments, the power source 220 is controlled by the controller 210 to a temperature set point based on the measurement from the temperature sensor 270. The temperature sensor 270 can be any temperature sensor known in the art that can measure the temperature of the electrically conductive member 250. In some embodiments, the temperature sensor 270 is not present.

In some embodiments, the power source 220 includes a transformer. In some embodiments, the transformer has 10 loops on its secondary side. In various embodiments, the transformer is a step-up transformer, a step-down transformer or a neutral transformer. In various embodiments, the power source is a DC source or a switching power supply.

The power source 220 is electrical connected to the electrically conductive member 230 via electrical connectors 240. In some embodiments, the electrically conductive member 230 is a tube. In some embodiments, the electrically conductive member 230 is coil shaped. In some embodiments, the electrically conductive member 230 has a length up to a few meters. In some embodiments, the length of the electrically conductive member 230 depends on a desired fluid flow range and desired ozone concentration at the outlet.

In some embodiments, a diameter of the electrically conductive member 230 depends on operating conditions of the member. In some embodiments, the electrically conductive member 230 has a diameter up to two inches.

In some embodiments, the electrically conductive member 230 is metallic. In some embodiments, the electrically conductive member 230 is any metal that is heated when power is applied. In some embodiments, the electrically conductive member 230 is thermally and electrically conductive (e.g., 21° C. about 9.8 W/m*° C. and about 130*10⁻⁶ Ohm*cm). In some embodiments, the electrically conductive member 230 can maintain its form in the presence of temperatures up to 1000° C. In some embodiments, the electrically conductive member 230 is substantially resistance to corrosion in the presence of HF.

In some embodiments, the electrical connectors 240 are centimeters long. In some embodiments, the electrical connectors 240 are meters long. In some embodiments, the electrical connectors 240 have a resistance that is below the resistance of the electrically conductive member 230. In some embodiments, the resistance of the electrical connectors 240 depends on length, diameter, and/or material of the electrical connectors 240. In some embodiments, the electrical connectors 240 are made of cooper. In various embodiments, the electrical connectors 240 can consist of a material with higher electrical conductivity than the metallic tube (e.g., aluminum, silver, gold).

The electrically conductive member 250 is in fluid communication with a chemical source (not shown) via the fluidic input to the electrically conductive member 250. In some embodiments, the chemical source is an ozone source. In some embodiments, the chemical source provides a chemical mixture. In some embodiments, the chemical source provides a single chemical.

The electrically conductive member 250 is in fluid communication with an outlet (not shown) via the fluidic output to the electrically conductive member 260.

During operation, a chemical mixture is input to the electrically conductive member 250. The power source 220 applies a voltage to the electrically conductive member 250. The electrically conductive member 250 heats up, thus the chemical mixture heats up.

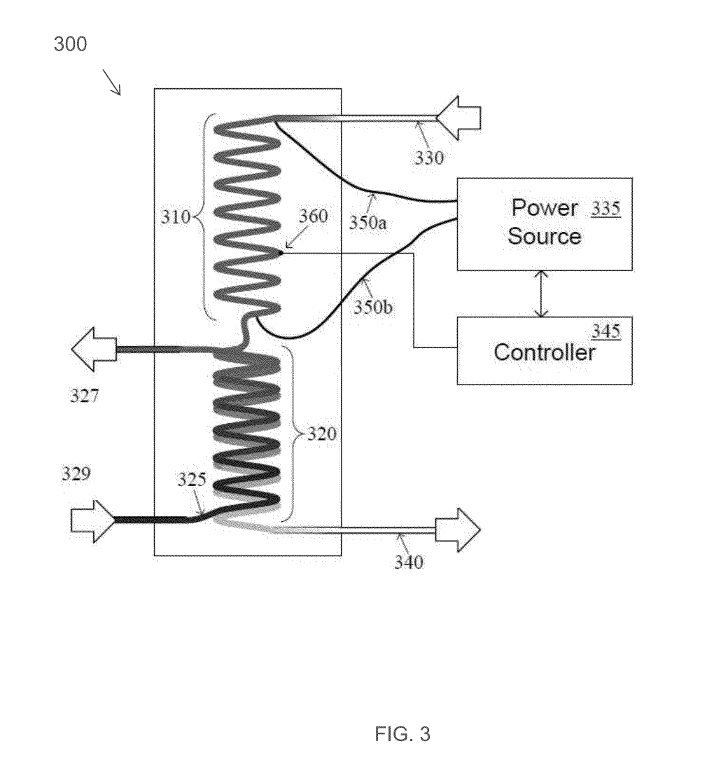

In some embodiments, the electrically conductive member 230 includes a first portion and a second portion. FIG. 3 is schematic representation of a system 300 for facilitating a chemical reaction, according to an illustrative embodiment of the invention. The system 300 includes an electrically conductive member 300 having a first portion 310 and a second portion 320, a cooling tube 325, a power source 335, a temperature sensor 360, a controller 345 and two electrical connectors 350a, 350b.

The electrically conductive member 300 includes a first portion 310, a second portion 320, an inlet 330 and an outlet 340.

The first portion 310 is a coil shaped tube capable of receiving a chemical from at inlet 330. The first portion 310 is electrically connected to the power source 335 via the two electrical connectors 350a, 350b. The first portion is coupled to the temperature sensor 360. The temperature sensor 360 and the power source 335 are both coupled to the controller 345. The controller 345 set a power set point for the power source based on the temperature sensor 360. In some embodiments, the temperature sensor 360 is not present.

The first portion 310 is in fluid communication with the second portion 320. The second portion 320 is a coil shaped tube capable of receiving the output of the first portion 310.

The second portion 320 is enclosed within the cooling tube 325. The cooling tube 325 is capable of receiving cooling water at an inlet 327 such that a coolant flows around an exterior of the second portion 320. The cooling water exits the cooling tube 325 at an outlet 329. The second portion 320 is capable of releasing the chemical mixture at the outlet 340.

In some embodiments, the first portion 310 is surrounded by an insulating material. In some embodiments, the insulation is surrounded by aluminum. In some embodiments, the first portion 310 is 1 meter long. In some embodiments, the second portion 310 is 1 meter long.

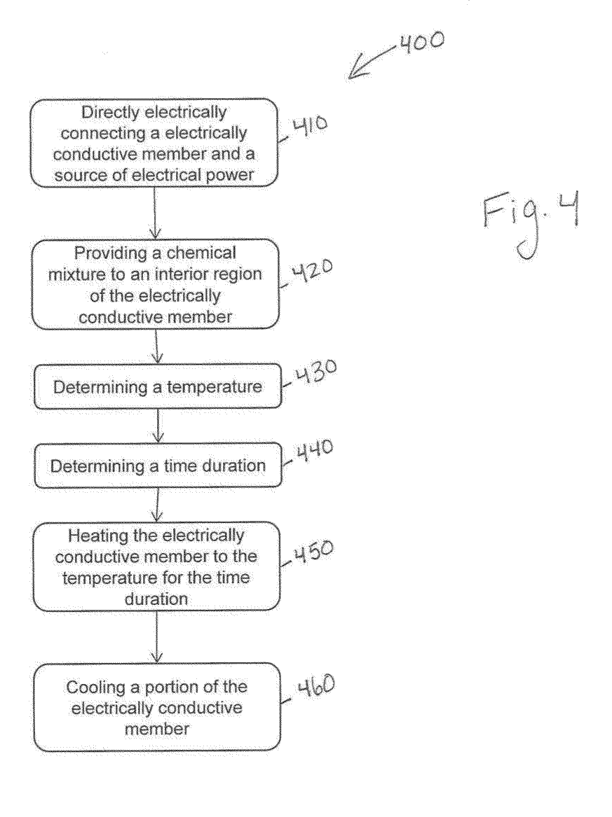

FIG. 4 is a flow diagram 400 for a method of facilitating a chemical reaction, according to an illustrative embodiment of the invention. The method involves directly electrically coupling an electrically conductive member and a source of electrical power (Step 410). For example, as shown in FIG. 2, the electrically conductive member 230 is directly coupled to the power source 220 such that no other components are between the power source 220 and the electrically conductive member 230.

In some embodiments, the source of electrical power provides 230 V AC. In some embodiments, the source of electrical power provides a power that depends on a desired temperature for the electrically conductive member. The method also involves providing a chemical mixture to an interior region of the electrically conductive member (Step 420). For example, as shown in FIG. 2, a fluidic input to the electrically conductive member 250 is capable of receiving a chemical mixture. In some embodiments, the chemical mixture is ozone, HF or any combination thereof.

The method also involves determining a predetermined temperature for the electrically conductive member (Step 430). In some embodiments, the predetermined temperature depends on the desired chemical reaction. For example, for a desired chemical reaction of destruction of ozone, the predetermined temperature is approximately 350° C. In various embodiments, the predetermined temperature depends on the chemical mixture, the volume of the chemical mixture, the type of material of the electrically conductive member, the size of the electrically conductive member, the shape of the electrically conductive member or any combination thereof (e.g., a shorter tube can require a higher temperature).

The method also involves determining a time duration during which the electrically conductive member should be heated (Step 440). The time duration can depend on the chemical mixture, the volume of the chemical mixture, the type of material of the electrically conductive member, the size of the electrically conductive member, the shape of the electrically conductive member, flow rate or any combination thereof. For example, for a low flow rate the heating and non-heating time relationship can be 50:50. An increase in flow rate can cause an increase in heating time. A decrease in flow rate can cause a decrease in heating time.

The method also involves heating the electrically conductive member to the predetermined temperature for the time duration (Step 450). For example, as shown in FIG. 2, a power source 220 is directly electrically coupled to the electrically conductive member 230 without a heating element there between. The power source 220 transmits power to the electrically conductive member 230 that is sufficient to cause the electrically conductive member 230 to heat to the desired temperature. The electrically conductive member 230 retains the chemical mixture to provide a chemical reactor for the chemical mixture and also provide heat to the chemical mixture. A separate heating element between the power source and the chemical reactor is not required to heat the chemical mixture.

In some embodiments, the method also involves cooling a portion of the electrically conductive member (Step 460) such that the chemical mixture is cooled. The chemical mixture can be cooled to a desired temperature. The desired temperature for the chemical mixture can be based on the chemical mixture, the volume of the chemical mixture, the type of material of the electrically conductive member, the size of the electrically conductive member, the shape of the electrically conductive member or any combination thereof. In some embodiments, a lower limit for the desired temperature depends on a dew point of the chemical mixture that avoids condensation within the electrically conductive member. In some embodiments, a higher limit for the desired temperature depends on an acceptable temperature level for off-gas to an exhaust system to be released.

In some embodiments, the portion of the electrically conductive member is cooled by water cooling. In various embodiments, the portion of the electrically conductive member is cooled by air cooling, liquid cooling (e.g. with oil), with heat exchanger, or any combination thereof.

While the invention has been particularly shown and described with reference to specific embodiments, it should be understood by those skilled in the art that various changes in form and detail may be made therein without departing from the spirit and scope of the invention as defined by the appended claims.

1. A method of facilitating a chemical reaction, the method comprising:
directly coupling an electrically conductive member and a source of electrical power, the electrically conductive member having an interior region configured to be substantially resistant to chemical corrosion and capable of retaining a chemical mixture therein;
providing the chemical mixture to the interior region of the electrically conductive member; and
heating the electrically conductive member to a predetermined temperature by controlling the electrical power applied to the electrically conductive member to cause a chemical reaction within the chemical mixture.

2. The method of claim 1 wherein the chemical reaction is ozone destruction.

3. The method of claim 1 further comprising heating the electrically conductive member to a predetermined temperature that is greater than 200 degrees Celsius.

4. The method of claim 3 selecting the predetermined temperature based on the chemical mixture, the type of electrically conductive member, or any combination thereof.

5. The method of claim 1, further comprising cooling a section of the electrically conductive member to cool the chemical mixture upon exiting the electrically conductive member.

6. The method of claim 1 wherein the electrically conductive member is a metallic tube.

7. The method of claim 1 wherein the electrically conductive member is single structure that is electrically and thermally conductive.

8. A system for facilitating ozone deconstruct, the system comprising:
a metallic tube that is substantially resistant to chemical corrosion and capable of retaining a chemical mixture including ozone therein, the metallic tube defining a first section and a second section and a diameter less than 50.8 mm and a length up to 15 m;
a power source directly electrically coupled to the metallic tube, the power source being configured to heat the first section of the metallic tube;
a controller electrically coupled to the power source, the controller controls power to the metallic tube such that when the chemical mixture including ozone flows into the metallic tube the chemical mixture including ozone is heated to cause ozone within the metallic tube to deconstruct.

9. The system of claim 8 wherein the power source and metallic tube are coupled by connecting one or more electrical wires to the metallic tube along the first section of the metallic tube.

10. (canceled)

11. (canceled)

12. (canceled)

13. The system of claim 8 further comprising a cooling section connected to the metallic tube along the second section of the metallic tube.

14. The system of claim 13 wherein the second section of the metallic tube is positioned relative to a coil shaped metallic tube that has coolant flowing there through such that the second section of the metallic tube is cooled.

15. The system of claim 13 wherein a heated section of the first section of the metallic tube that is connected to the second section of the metallic tube is in fluid connection with an inlet of the first section of the metallic tube such that heat from the heated section of the first section of the metallic tube heats the chemical mixture entering the first section of the metallic tube.

16. (canceled)

17. The system of claim 8 wherein the first section of the metallic tube and the second section of the metallic tube have a coil shape.

18. The system of claim 8 wherein the power source is a transformer.

19. The system of claim 18 wherein the transformer has 10 loops on a secondary side of the transformer.

20. he system of claim 8 wherein the power source is a DC source.

21. The system of claim 8 wherein the power source is a switching power supply.

22. The system of claim 8 wherein the power source is a controlled source.

23. The system of claim 8 wherein the temperature of the metallic tube is controlled.

24. The system of claim 8 wherein the temperature control is a closed loop control.

25. The system of claim 19 further comprising a thermostat in connection with the transformer such that the thermostat controls the transformer to supply power to the metallic tube to cause the metallic tube to heat to the desired temperature.

26. A method of destructing ozone, the method comprising:
directly coupling an electrically conductive member and a source of electrical power, the electrically conductive member having an interior region configured to be substantially resistant to ozone corrosion and capable of retaining ozone therein;
providing the ozone into the interior region of the electrically conductive member; and
heating a first section of the electrically conductive member to a predetermined temperature by controlling the electrical power applied to the electrically conductive member to cause the ozone to be destroyed.

27. (canceled)
